(19) United States
(12) Patent Application Publication
(10) Pub. No.: US 2012/0197729 A1
(43) Pub. Date: Aug. 2, 2012

(54) SHELF-BASED PROMOTION TARGETING

(75) Inventors: Robert Bertram, Winnetka, IL (US); Shakh Alam, Chicago, IL (US)

(73) Assignee: UNICOUS MARKETING, INC., Rosemont, IL (US)

(21) Appl. No.: 13/361,924

(22) Filed: Jan. 30, 2012

Related U.S. Application Data
(60) Provisional application No. 61/437,650, filed on Jan. 30, 2011.

(51) Int. Cl. G06Q 30/02; H04B 7/00

(52) U.S. Cl. 705/14.64

(57) ABSTRACT

A system and method for implementing promotions in a retail environment is provided. Transceivers located at one or more locations within the retail environment are adapted for communication with personal mobile devices carried by shoppers. Promotions can be offered and accepted based on factors such as a shopper's location within a store, shopper identity, shopper purchase history, shopper promotion redemption history, date and time and other factors. Applicable promotions are then activated within the retailer point-of-sale system for application during checkout.

### BACKGROUND

The present invention relates in general to the marketing of consumer products, and in particular, to conveyance of promotional information to consumers within proximity of a retail location.

A popular technique for promotion of consumer products involves offering of discounts or rewards to consumers for specific products during specific periods of time. Traditionally, such promotions have taken place through paper coupons distributed to consumers. Paper coupons can be distributed broadly, such as via newspaper inserts or bulk mailings.

Paper coupons can also be distributed in a localized manner within a particular retailer, via shelf-based coupon dispensers. Typically, such dispensers are temporarily attached to the retail store shelving near the area at which a particular product is sold. Any consumer passing the dispenser is presented with the opportunity to take a coupon for a discount on a corresponding product, thereby encouraging consumers to select the discounted product over nearby competing brands.

While shelf-based coupon dispensers allow for targeting of consumers by physical location (e.g. the area immediately surrounding the dispenser), other aspects of the shelf-based coupon dispenser are less selective. For example, shelf-based coupon dispensers typically provide coupons having a uniform discount value, regardless of the identity of the consumer using the coupon. Additionally, shelf-based coupon dispensers provide discount opportunities to every customer equally, without regard to the customer's buying patterns, store loyalty card status or other individualized information.

### BRIEF DESCRIPTION OF THE DRAWINGS

FIG. 1 is a block diagram of a portion of a retail environment, in accordance with one embodiment of the invention.

FIG. 2 is a schematic block diagram of a shelf transceiver, in accordance with an exemplary embodiment.

FIG. 3 is a schematic block diagram of a shelf-based promotion system, in accordance with an exemplary embodiment.

FIG. 4 is a flowchart illustrating operation of a shelf-based promotion targeting system to create a targeted promotion, in accordance with an exemplary embodiment.

FIG. 5 is a flowchart of a subprocess for generating a targeted promotion, in accordance with an exemplary embodiment.

FIG. 6 is a flowchart of a process for redeeming a targeted promotion, in accordance with an exemplary embodiment.

FIG. 7 is a messaging diagram illustrating sequence of communications, in accordance with an exemplary embodiment.

### DETAILED DESCRIPTION OF THE DRAWINGS

While this invention is susceptible to embodiment in many different forms, there are shown in the drawings and will be described in detail herein several specific embodiments, with the understanding that the present disclosure is to be considered as an exemplification of the principles of the invention and is not intended to limit the invention to the embodiments illustrated.

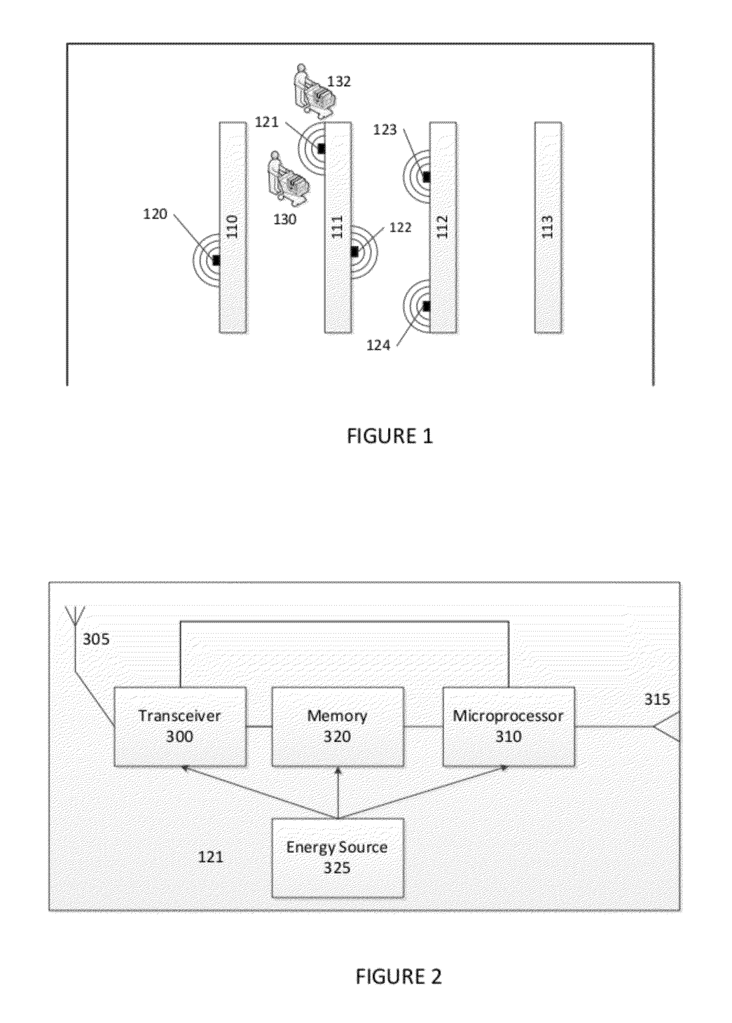

FIG. 1 illustrates a portion of a retail establishment utilizing a shelf-based promotion targeting system according to a first embodiment of the invention. The establishment includes multiple aisles with product shelves 110-113. Product shelves 110-113 contain a variety of retail products along their lengths, grouped so that multiple brands of similar products are generally adjacent one another. Wireless transceivers 120-124 are positioned amongst shelves 110-113 proximate product groups for which a promotion is offered.

While transceivers 120-124 are commonly referred to herein as “shelf transceivers”, it is understood and expressly contemplated that such transceivers could be positioned at locations other than product shelves. For example, in some embodiments, such transceivers could be mounted on a store ceiling, or proximate a light fixture. In either case, the location of the transceiver relative to the store and/or products displayed in the store can be determined. It is further contemplated that wireless retail communication devices other than transceivers could be utilized in other embodiments of the present system. For example, short range transmitters (not having a receiver functionality) could act as local-area beacons within a retail establishment, providing signals that can be received and acted upon by a properly-configured personal communication device.

The embodiment of the shelf-based promotion targeting system illustrated in FIG. 1 leverages the increasing popularity amongst retail shoppers of personal wireless communication devices, such as cellular telephone smartphones, tablet computers and other consumer electronic communication devices. Smartphones, such as the Apple™ iPhone™, phones utilizing the Android™ operating system, Windows™ Phone, or RIM™ Blackberries™ typically incorporate communications capabilities over a variety of wireless communications protocols, including cellular data transmission protocols (e.g. 3G, LTE), 802.11 wireless Ethernet or WiFi (802.11 a/b/g/n/ac), and Bluetooth™. The system of FIG. 1 enables users to receive targeted promotions when they are within physical proximity of an item being promoted.

Shelf transceivers 120-124 are capable of wireless message transmission. In the embodiment of FIG. 1, shelf transceivers 120-124 communicate via a Bluetooth short-range wireless communications protocol. However, it is understood that other embodiments of the invention could utilize different wireless communication protocols, without departing from the contemplated scope. In order to maximize the efficiency of communications and reduce constraints on the system, it may be desirable for transceivers 120-124 to utilize broadcast, unicast and/or multicast messaging methods, to the extent they may be implemented within a selected wireless communication protocol.

In the embodiment of FIG. 1, transceivers 120-124 transmit messages at regular intervals or in response to a “polling” request. The messages contain a unique digital identifier identifying the device, a status on the health of the device (e.g. battery level), a time stamp for synchronization, and a time dependent value (e.g. key). All or part of the message may be asymmetrically encrypted.

Preferably, the unique digital identifier is uniquely associated with that particular transceiver, distinguishing the transceiver from all other shelf transceivers across all retail establishments. In such a system, the transceiver's digital identifier can be uniquely correlated with a particular retailer, retailer store, and a particular location within a particular store. Further, an association is made between a transceiver (its digital identifier) and a grouping of one or more product categories (e.g. Cold Cereal, Catsup, Mustard . . . ) located proximate to the transceiver (within communications range of the transceiver), or a particular named location within the store (e.g. entrance/exit, checkout . . . ) at the time of transceiver installation.

In accordance with one option for deploying the system of FIG. 1, transceivers are installed specifically for a promotion and then removed at the end of the promotion. In an alternative deployment option, shelf transceivers may be distributed throughout an establishment at predetermined locations. The shelf transceivers distribution plan can then be overlaid with the store's changing (full or partial store reset) shelf product plan (e.g. store planogram), to correlate each shelf transceiver's unique digital identifier with the then current grouping of one or more product categories or store locations proximate each transceiver at any given time. Regardless, at the time of the installation, preferably the transceiver's time stamp is recorded in RAS 290 (described further below) for purposes of authenticating the transceiver's time dependent value incorporated into future messages (also described further below).

Shelf transceivers 120-124 (and their corresponding unique digital identifiers) may each be associated with a single promotional offer for a product located proximate the shelf transmitter physical location. Alternatively, a shelf transceiver and its digital identifier may be associated with multiple promotional offers, preferably for different products that are all proximate the corresponding shelf transmitter. Finally, it is also possible that during given periods of time, a shelf transceiver will be installed without any corresponding promotions.

FIG. 2 is a schematic block diagram of shelf transceiver 121. Shelf transceiver 121 includes microprocessor 310. Microprocessor 310 accesses memory 320, and can be programmed and configured via a communication port 315. Microprocessor 310 generates digital messages, such as a digital identifier, which are transmitted via transceiver 300 and antenna 305. Shelf transceiver 121 is powered by energy source 325. It is contemplated that shelf transceiver 121 can be implemented in a compact, lightweight physical package to enable easy mounting in a concealed position on a store shelf or overhead mounting, avoiding additional cluttering of retail shelves.

In some embodiments, energy source 325 may comprise an internal battery. The internal battery may be field-changeable. The internal battery may also be rechargeable by, e.g., plugging a powered communications cable (e.g. powered USB) into communication port 315. Regardless, preferably, low-power electronics will be utilized within shelf transceiver 121 so that the internal battery within energy source 325 will power shelf transmitter 121 for an extended period of time (typically at least the length of a promotion, and in some embodiments, a longer 6-12 month period) to minimize maintenance costs associated with replacing or recharging the battery.

In some deployments, particularly with large numbers of transceivers and/or where transceivers are commonly maintained in fixed positions across multiple promotions, it may be desirable to further minimize periodic maintenance efforts and expense to replace and/or recharge batteries. In such circumstances, it may be desirable to utilize a continuous energy source, such as an external power supply. In embodiments where the transceiver is exposed to lighting, such as bright overhead lighting commonly found in retail establishments, energy source 325 may include a solar energy cell, and a charging circuit operable to recharge the internal rechargeable battery with energy generated by the solar cell, thereby extending the operating time during which the device can operate in a standalone manner. In yet other embodiments, energy source 325 may include a receiver for receipt of external RF energy to also recharge and extend the life of an internal battery.

As depicted in FIG. 1, shoppers 130 and 132 move amongst shelves 110-113 carrying smartphones or other portable wireless communication devices. As shoppers 130 and 132 pass by shelf transceivers 120-124, they are exposed to periodic wireless transmissions from nearby shelf transceivers. Communications from transceivers 120-124 can be initiated in one or more of numerous ways. One such mode of transmission is for a transceiver to operate as a beacon, sending out a message at a regular interval for receipt by compatible consumer devices, should any happen to be nearby. Another such mode of transmission is initiated in response to consumer device requests or polls. Once the consumer device is known to be inside a retail location, periodic polls or requests can be generated by the consumer device and received by nearby shelf transceivers, thereby triggering a response by the shelf transceiver.

In the illustrated embodiment, the power level of each shelf transmitter (e.g. the power level output from transceiver 300 within shelf transmitter 121) is configured at a relatively low level, so that smartphones held by shoppers 130 and 132 receive those transmissions only when they are nearby the shelf transceiver. Optionally, in some embodiments, the power level of each shelf transmitter can be configured at installation time to control the range at which transmissions can be received. This may be desirable to accommodate different space layouts and RF transmission environments experienced in different retail locations.

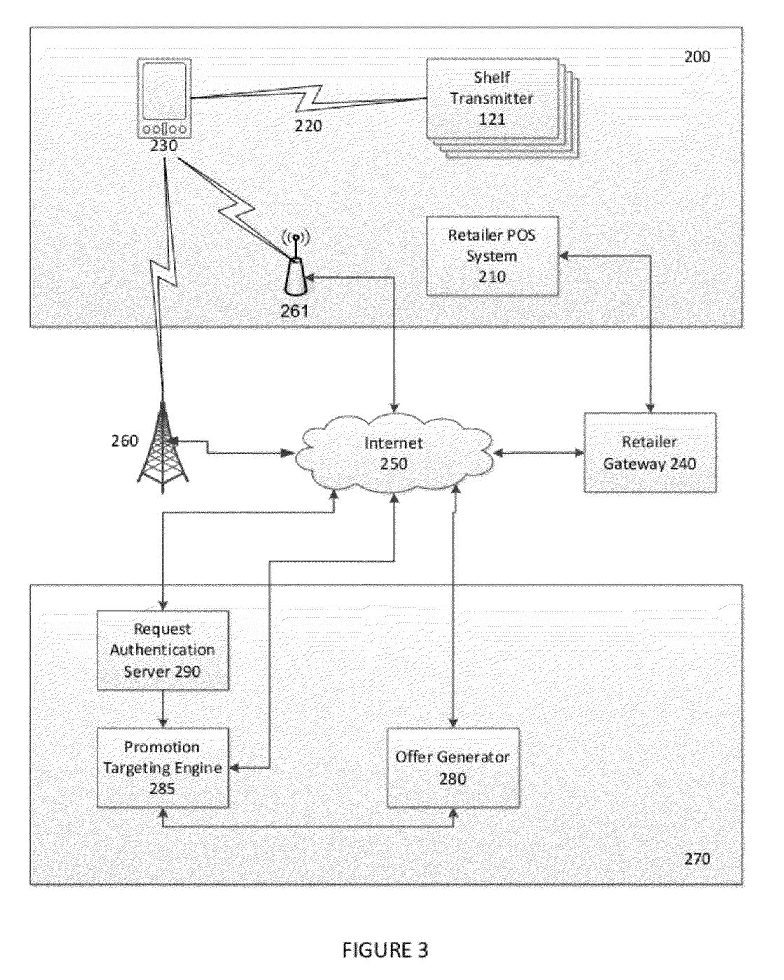

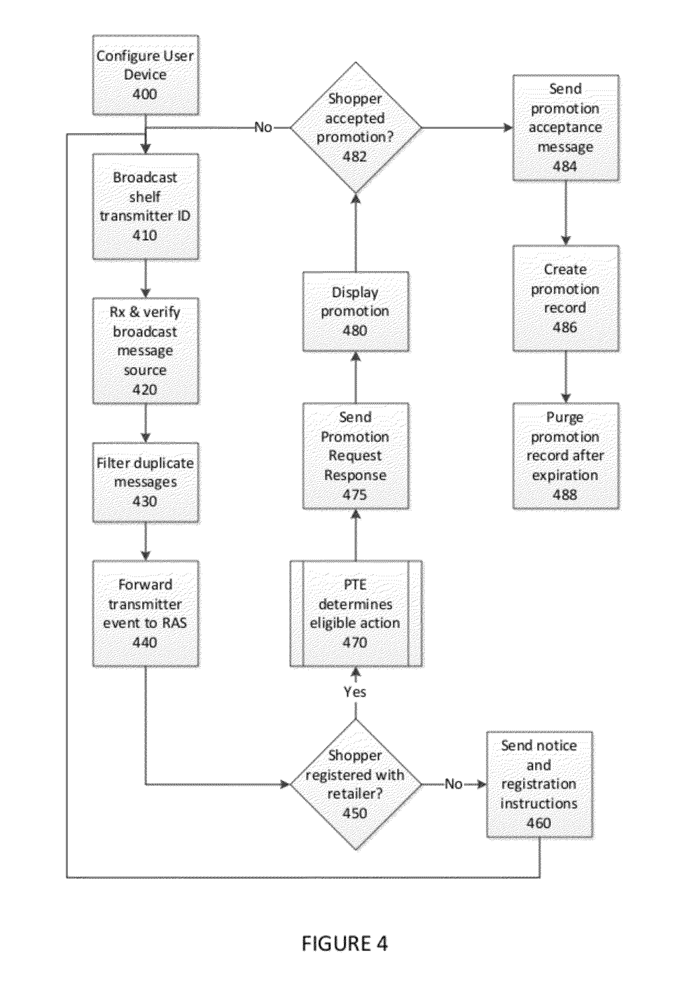

The shelf-based promotion targeting system of FIG. 1 can be implemented by a distributed computing environment, such as that illustrated in the embodiment of FIG. 3. FIG. 4 depicts an exemplary flowchart of operations through which the system of FIG. 3 can create and deliver targeted promotions to shoppers.

In step 400 of FIG. 4, a store shopper configures smartphone 230 to operate in conjunction with the system of FIG. 3. In some embodiments, this configuration may involve the wireless downloading and installation of a custom software application from an “app store.” The user may also have to configure smartphone 230 to accept wireless (RF) messages, such as Bluetooth messaging, from the shelf transceivers. The user may also have to configure smartphone 230 application with loyalty number information for the retailers at which they shop.

In step 410, shelf transceiver periodically transmits a low-power unicast or multicast message containing a unique digital identifier via wireless communications link 220. Optionally, the unique digital identifier message may be asymmetrically encrypted.

The message transmitted in step 410 is received by smartphone 230, at which point smartphone 230 determines the authenticity of the message source, and filters out messages received from other sources than system shelf transceivers (step 420). In some embodiments, step 420 is implemented by a custom software application operating on smartphone 230. Authenticated messages are then filtered to eliminate duplicates based upon the received message's digital identifier (step 430). For example, smartphone 230 may be configured to disregard digital identifiers received when the same digital identifier has previously been received within a predetermined period of time, e.g., one minute. This avoids processing multiple instances of the same message when a user lingers in the area of a shelf transmitter for a period of time greater than the period during which the shelf transmitter repeats its broadcast messages. Further filtering of messages occurs if previous requests to Request Authentication Server 290 indicate that no promotions for the user are associated with the received digital identifier for the current time period.

In step 440, smartphone 230 forwards a shelf transceiver message (i.e. receipt of the unique digital identifier) to Request Authentication Server 290. The shelf transceiver message forwarded in step 430 contains content including payload from the broadcast message received in step 420 (e.g. a Bluetooth message containing the shelf transceiver digital identifier), as well as a smartphone identifier uniquely associated with smartphone 230. Content that may serve as a smartphone identifier includes the telephone number associated with smartphone 230, a system-generated identifier created during application installation or configuration, or the International Mobile Equipment Identifier (IMEI) number associated with smartphone 230.

In the embodiment of FIG. 3, smartphone 230 communicates with Request Authentication Server 290 via cellular data network 260 and Internet 250, or via wireless Ethernet 261 and Internet 250. Request Authentication Server 290 can be hosted by a third party service provider 270 serving to manage targeted promotions. While the illustrated embodiment utilizes cellular communications network 260 for data communications, it is also understood that alternative embodiments could utilize other means of digital communications, such as an in-store 802.11 wireless Ethernet network 261. Additionally, alternative network topologies could result in various portions of the service provider 270 infrastructure being relocated to an in-store data network.

In step 450, Request Authentication Server 290 determines whether the consumer that is associated with the received smartphone identifier is registered with the retailer that is associated with the forwarded shelf transceiver digital identifier. If so, the system proceeds to step 470. If not, Request Authentication Server 290 sends a message back to smartphone 230 (via, e.g., Internet 250 and cellular communications network 260) informing the consumer that they are not registered to receive promotions from the retailer at which they are shopping, and providing instructions to register (step 460). The registration message may include an option to enter personal information directly into smartphone 230 to register immediately. At that point, smartphone 230 returns to await broadcast of another shelf transceiver digital identifier upon which it may act.

The time dependent value, or key, transmitted by the shelf transceivers, may be utilized to further authenticate and authorize messaging within the system. For example, the time dependent value may be an algorithmically-generated, pseudorandom value utilized as a time-synchronized password. In such an embodiment, Request Authentication Server 290 may verify the time dependent value received from a shelf transceiver and conveyed by smartphone 230, against the expected value at the time a transmission from smartphone 230 is received by Request Authentication Server 290. Through this verification, the system can reduce opportunities for individuals to obtain access to promotions by retransmitting broadcasts that had been previously received.

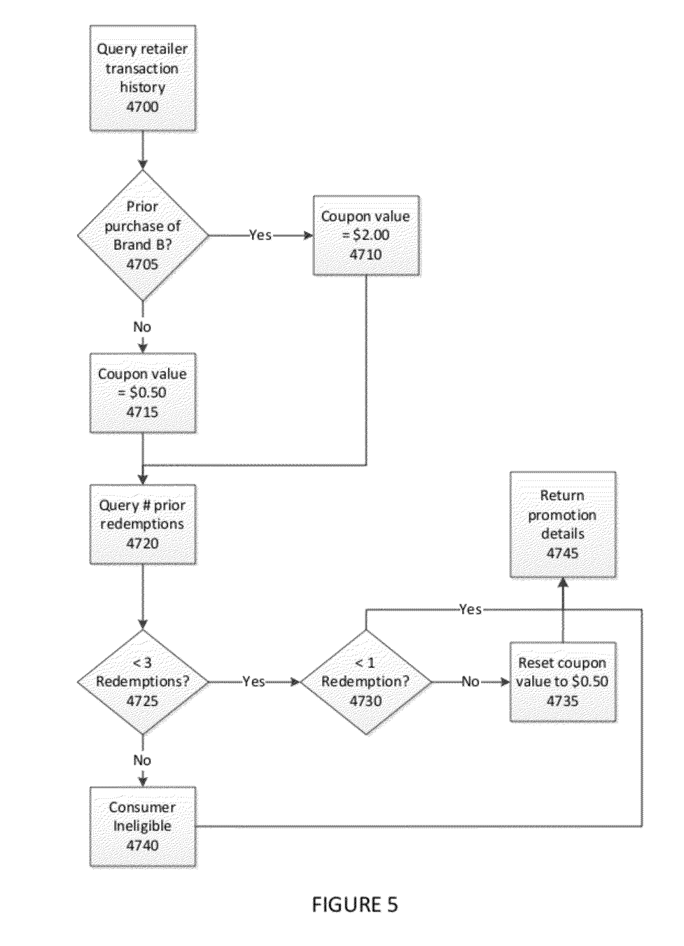

In the event that the shopper is associated with the retailer, Request Authentication Server 290 passes information from the shelf transceiver message to Promotion Targeting Engine 285 (subprocess 470). An embodiment of subprocess 470 is illustrated in further detail in FIG. 5. In general, Promotion Targeting Engine 285 (“PTE 285”) determines whether the shelf transceiver message should be acted upon and what action to take. A variety of promotion types can be configured, as well as numerous criteria for their offering. Examples of promotion types include discounts/coupons, advertisements, consumer surveys, and offering of a recipe. Criteria to determine which promotion to offer and details of the promotion content (e.g. coupon value or recipe type) may include, without limitation, one or more of the following: promotion event time limitations, time of day, the identity of the shopper, previously-configured user preferences, whether a shopper is associated with a store loyalty program, product categories associated with the transceiver digital identifier, a named location associated with the transceiver identifier (e.g. store entrance, checkout lanes), prior use of the same promotion with the same shopper, prior use of the same promotion with other shoppers, quantity of prior redemptions (e.g. to limit redemption count or total redemption value), consumer purchasing history, personal information provided by consumer, whether the consumer has previously opted out of a promotion category (e.g. no pet food offers for consumers without pets), whether the consumer has previously accepted or used a promotion for a competing product, and information determined through analysis of a user's information and activity within social networking systems.

FIG. 5 illustrates an example of the operation of PTE 285 in subprocess 470. In the embodiment of FIG. 5, shelf transmitter 121 is positioned proximate shelves containing multiple brands of peanut butter. A promotion is configured to offer a coupon for a 50 cent discount on Brand A peanut butter to all shoppers that are registered with the retailer associated with the shelf transmitter identifier, while offering a greater value coupon worth $2.00 discount to consumers having previously purchased peanut butter from competing Brand B. The promotion runs during the month of June. Shoppers are limited to a single redemption of the $2.00 coupon per shopping trip or other defined offer redemption period, and the total number of times a single shopper may participate in the promotion is three.

In step 4700, PTE 285 queries Retailer Gateway 240 via Internet 250, to determine whether the transaction history for the shopper associated with the received smartphone identifier includes purchase of Brand B peanut butter. In step 4705, PTE 285 evaluates the query response. If yes, the potential coupon value is determined to be $2.00 (step 4710). If not, the potential coupon value is determined to be $0.50 (step 4715). Next, PTE 285 queries its own redemption records to determine the number of times the shopper associated with the smartphone identifier has redeemed the current promotion (step 4720). The response to the query is evaluated in steps 4725 and 4730. If the number of prior redemptions of the current promotion is determined to be greater than three, the consumer is deemed ineligible for a further promotion (step 4740). If the consumer is eligible for the promotion, a determination is made as to whether this is the consumer's first redemption (step 4730). If so, the previously-determined coupon value is left unaltered and eligibility for the coupon amount is returned (step 4745). If the consumer has previously redeemed the promotion, then the coupon value is reset to $0.50 (step 4735) and the eligibility for a $0.50 coupon is returned (step 4745).

After PTE 285 determines an eligible action, a promotion request response is sent to smartphone 230 (step 475). The promotion response request includes a confirmation of acceptance by PTE 285, a display payload, and a Promotion Request Response globally unique identifier (PRR GUID). The display payload includes the messaging to be displayed to the consumer. For example, in some implementations of the system, the display payload may comprise HTML code conveying the availability, nature and amount of a coupon offer. The PRR GUID is used to track and reference the promotion offer, e.g., during any subsequent redemption attempt by the user, and for security audit purposes.

In step 480, smartphone 230 displays the promotion offer to the shopper associated with that device. The display may involve a combination of elements to help communicate the promotion to the shopper. For example, the display payload sent in step 475 can be displayed on a graphical display on smartphone 230. Additionally, smartphone 230 may emit a sound or vibration to further attract the shopper's attention.

In some embodiments, smartphone 230 may test for whether the consumer affirmatively accepts the promotion (step 482). Acceptance testing may be utilized to reduce the extension of promotion benefits in scenarios where the promotion did not influence a shopper's buying decision. For example, a manufacturer may desire not to extend a coupon discount to a shopper who failed to notice the coupon offer but nonetheless purchased the product subject to the coupon by happenstance. Therefore, if a shopper fails to accept a promotion offer in step 482, the operation of smartphone 230 may return to a monitoring state in which new shelf transmitter broadcasts can be detected. A requirement for affirmative acceptance may be configured as a characteristic of the promotional offer, and communicated to smartphone 230 as part of the promotion response request sent in step 475.

If the user of smartphone 230 accepts a promotion in step 482, a promotion acceptance message is transmitted from smartphone 230 to Offer Generator 280 (step 484). The promotion acceptance message includes an acceptance indicator, the PRR GUID, and the consumer's smartphone identifier. Offer Generator 280 responds by creating a Promotion Record containing information describing the accepted promotion (step 486). In the embodiment of FIG. 3, the Promotion Record is created and stored within Retailer Gateway 240, via Internet 250. The Promotion Record contains information required for a retailer's Point Of Sale system to identify and apply an accepted promotion during the course of a consumer transaction. For example, the Promotion Record may include the retailer loyalty card number associated with the user of smartphone 230, the store at which the promotion is available, the list of product UPCs to which the promotion applies, quantity purchase requirements, use limit, the nature of the promotion (e.g. discount coupon), and the amount of the promotion (e.g. coupon value). If a promotion is designed to be used during the current shopping period only, Retailer Gateway 240 can be configured to purge unused Promotion Records after a predetermined period of time, such as 4 hours (step 488).

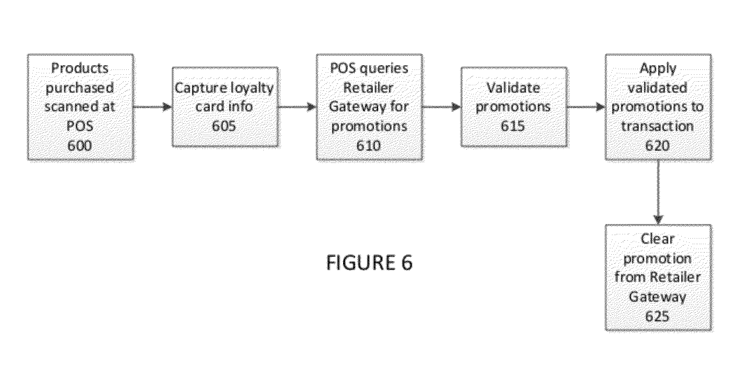

FIG. 6 illustrates a process by which previously-created promotions can be redeemed. In step 600, the shopper approaches the retailer point of sale (POS) 210, at which purchased products are scanned. The shopper then presents a retailer loyalty card, which is captured by POS system 210 and associated with the current purchase transaction (step 605). POS system 210 then queries Retailer Gateway 240 for any promotions assigned to the shopper's loyalty card (step 610). The response of Retailer Gateway 240 in step 610 will include promotions previously created during the process of FIG. 5. POS system 210 then validates promotions that were received in step 610 to determine whether they apply to the current transaction (step 615). If so, validated promotions are applied (step 620), and POS system 210 clears the used promotion from Retailer Gateway 240 (step 625). Records indicating the acceptance or application of coupons by the POS to the shopper are made available via the Retailer Gateway 240, and preferably stored by the promotion targeting system. Usage can be tracked for any of a variety of purposes, including, without limitation: limiting repeated use of an offer by a consumer, limiting the total spend by a manufacturer on a given promotion, and analysis of the effectiveness of the promotion.

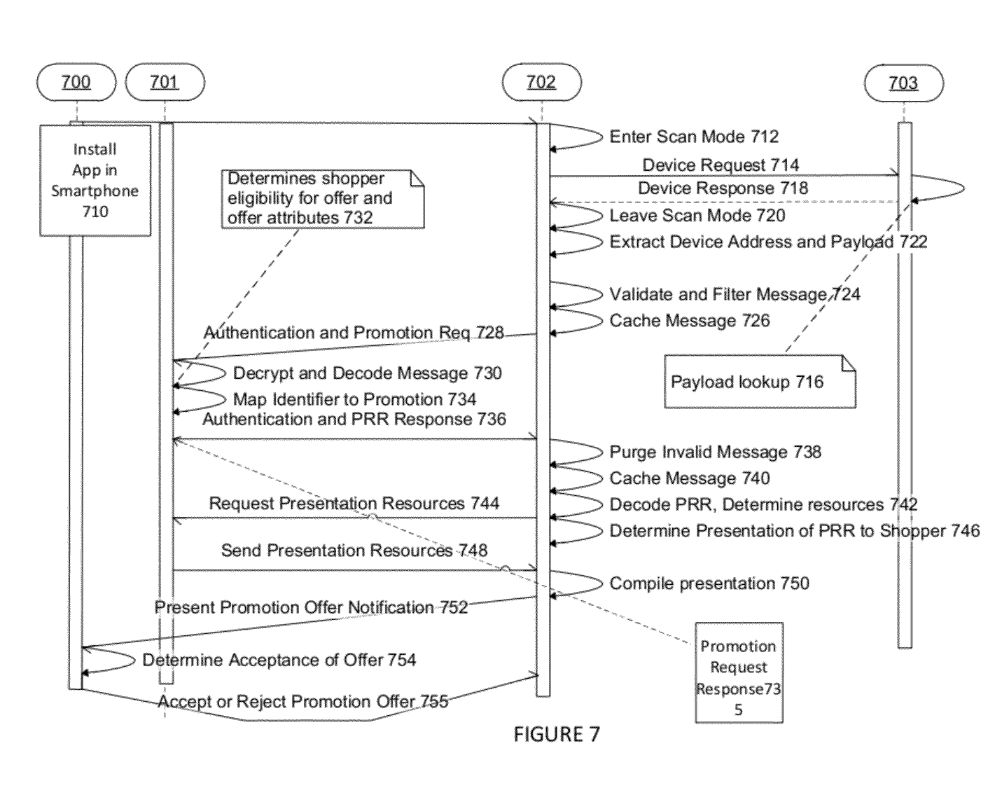

FIG. 7 illustrates a further embodiment of a messaging sequence that can be implemented between a shopper, a promotion targeting service, software operating on a shopper's personal wireless communication device, and a retail wireless communication device, such as a shelf transceiver. Shopper column 700 represents interaction with a shopper in a retail establishment. Promotion targeting service (PTS) column 701 represents interaction with the promotion targeting service. Smartphone software column 702 represents interaction with a software application implemented by a shopper's smartphone. Shelf transceiver column 703 represents interaction with a retail shelf transceiver. Time is represented along the vertical axis of FIG. 7, progressing downwards.

During interaction 710, shopper 700 acts to install a software application on smartphone 702. Once the application is installed and activated, smartphone 702 enters a scan mode (interaction 712), during which it periodically initiates device requests (interaction 714) via Bluetooth messaging. If shelf transceiver 703 is within the range of Bluetooth communications with smartphone 702, shelf transceiver 703 receives the smartphone polling request and performs a payload lookup (interaction 716) to determine payload content. A device address identifier associated with shelf transceiver 703 is then transmitted, along with encrypted payload inclusive of the digital identifier, in interaction 718. Upon receiving the shelf transceiver response, smartphone software 702 leaves scan mode (interaction 720) and extracts the shelf transceiver device address and payload from the received communication (interaction 722).

Smartphone software 702 then operates to validate and filter the received message in interaction 724, while also caching the received message (interaction 726). In interaction 728, smartphone software 702 operates to transmit a message to promotion targeting service 701 containing authentication information and requesting promotions. Promotion targeting service 701 decrypts and decodes the message (interaction 730) and determines shopper eligibility for offers and associated offer attributes (interaction 732). If the shopper is eligible, the promotion targeting system maps the digital identifier to available promotions in interaction 734.

In interaction 736, an authentication and promotion request response 735 is conveyed from promotion targeting service 701 to smartphone software 702. The response is validated, and purged if invalid (interaction 738). Otherwise, the response is cached (interaction 740). In interaction 742, the promotion record response is decoded and required resources are determined. The required resources are requested from promotion targeting service 701 in interaction 744. Smartphone software 702 then determines whether or how the promotion will be presented to the shopper (interaction 746). Promotion targeting system 701 responds in interaction 748 by sending presentation resources to smartphone software 702. Smartphone software 702 then compiles the presentation of the promotion (interaction 750) and presents a promotion offer notification to shopper 700 (interaction 752). In interaction 754, shopper 700 determines whether the offer will be accepted. Acceptance or rejection of the promotion is then conveyed to smartphone software 702.

While certain system infrastructure elements are illustrated in particular configurations (e.g. separate Request Authentication Server 290, Promotion Targeting Engine 285 and Offer Generator 280), it is understood and contemplated that functional elements can be readily integrated and/or implemented via various alternative hardware or software abstractions, as would be known to a person of skill in the field of information systems design. Moreover, while certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of the appended claims.

What is claimed is:

1. A promotion targeting system for implementation within a retail establishment comprising:
One or more retail wireless communication devices positioned within said retail establishment, said retail wireless communication devices each comprising a wireless transmitter configured for transmission using a short range communications protocol of a first digital identifier code that distinguishes said retail wireless communication devices from one another;
A personal wireless communications device carried by a shopper, said personal wireless communications device comprising: a first wireless transceiver for communications via said short range communications protocol, a second wireless transceiver for communications via a secondary communications network, a microprocessor and a display screen;
A request authentication server configured to (a) receive a transmission from the personal wireless communication device containing said first digital identifier code and a second digital identifier code, said second digital identifier code uniquely associated with said personal wireless communications device, and (b) respond by transmitting a promotional message to said wireless communications device, said promotional message containing information relating to a product positioned in the proximity of said retail wireless communication device.

2. The system of claim 1, in which one or more of said one or more wireless transceivers are positioned proximate products for which a promotion is offered, and in which said promotional message contains information relating to a product positioned in the proximity of said retail wireless communication device.

3. The system of claim 2, in which said one or more wireless transceivers are mounted to retail product shelves.

4. The system of claim 1, in which said one or more wireless transceivers are mounted on a ceiling of said retail establishment.

5. The system of claim 4, in which said one or more wireless transceivers further include an energy source, said energy source comprising a rechargeable battery, a solar cell, and charging circuitry adapted to charge the rechargeable battery with energy generated by the solar cell.

6. The system of claim 1, in which said short range communications protocol is a Bluetooth communications protocol.

7. The system of claim 1, in which said secondary communications network is a cellular data network.

8. The system of claim 1, in which said secondary communications network is a wireless Ethernet network.

9. The system of claim 1, in which:
the one or more retail wireless communication devices are further configured to transmit a device status message, a time stamp, and a time dependent value;
the personal wireless communications device is configured to relay the time dependent value to the request authentication server; and
the request authentication server is further configured to compare the time dependent value against an expected value based upon the first digital identifier to determine whether the transmission from the personal wireless communication device is authenticated.

10. The system of claim 1, in which each of said retail wireless communication devices further comprises a rechargeable battery, a solar cell, and a charging circuit operable to recharge said rechargeable battery using said solar cell.

11. A method for providing a retail promotion to a shopper carrying a personal wireless communications device within a retail establishment, comprising the steps of:
transmitting, by one of a plurality of retail wireless communication devices within a retail establishment, a first message using a short-range wireless communications protocol, said first message comprising a first identifier code uniquely associated with said one of said retail wireless communication devices;
receiving the first message by the personal wireless communications device;
in response to receipt of the first message, transmitting a second message from the personal wireless communications device to a server, the second message containing said first identifier code and a second identifier code, said second identifier code being associated with the personal communications device;
transmitting a third message from the server to the wireless communications device, the third message containing information describing a promotion associated with a retail product located in the proximity of the retail wireless communication device.
